(19) United States
(12) Patent Application Publication
(10) Pub. No.: US 2006/0088738 A1
(43) Pub. Date: Apr. 27, 2006

(54) Fuel cell system and control method

(75) Inventor: Takeshi Aso, Kanagawa (JP)

Correspondence Address: FOLEY AND LARDNER LLP;SUITE 500, 3000 K STREET NW, WASHINGTON, DC, 20007, US

(73) Assignee: Nissan motor co., Ltd

(21) Appl. No.: 10/540,858

(22) PCT Filed: May 12, 2004
(86) PCT No.: PCT/JP04/06664

§ 371 Date: Jun. 27, 2005

(30) Foreign Application Priority Data
May 15, 2003 (JP) 2003-137801

(51) Int. Cl. H01M 16/00; H01M 8/04

(52) U.S. Cl. 429/9; 429/22; 429/23; 429/24; 429/61; 429/13

(57) ABSTRACT

During a normal control (CP) having a fuel supply (3) supplying a fuel (Fg), an air supply (3) supplying an oxidizer (Og), a stack (1) of fuel cells generating power with the fuel and the oxidizer supplied, a battery (7) as a secondary cell operable for power charge and discharge, and a power distributor (4) distributing power from the stack to a main load (5) and operable for distribution of power from the stack to the battery and from the battery to the load, after a startup with the stack and the battery warmed-up, a controller (8) serves for raising a temperature (Ts) of the stack when a possible generation (Gp) of power is reduced and for raising a temperature (Tb) of the battery when a possible charge (Cp) of power or a possible discharge (Dp) of power is reduced, to maintain stable power supply to the load even under a continued low-output condition.

### TECHNICAL FIELD

The present invention relates to a fuel cell system and an associated control method, and particularly, to a fuel cell system to be mounted in a vehicle (e.g. fuel cell automobile or train), for power supply to a set of electrical loads including a vehicular drive motor and a fuel cell stack's peripherals, and an associated control method.

### BACKGROUND ART

Japanese Patent Application Laying-Open Publication No. 9-231991 has disclosed techniques for a fuel cell system to normally supply power to a set of electrical loads including a drive motor and stack peripherals.

To cope with a demand for excessive power on a fuel cell stack under a low temperature condition that merely allows generation of reduced power, the fuel cell system is adapted to supply power of a charged battery (secondary cell) to the motor, controlling the stack for low-output generation to supply power therefrom simply to the peripherals and minor loads drivable by low currents.

### DISCLOSURE OF INVENTION

However, in probably most situations where the stack has a low temperature condition, the battery may also have a low temperature condition with a reduced performance in charge and discharge. Stored energy in the battery may thus be limited, with a resultant failure to supply sufficient power to the motor.

For example, in a fuel cell vehicle after complete warm-up, the battery as well as the stack may experience a falling temperature, as the vehicle is parked or travels at a low speed in a cold weather. Still less, power generation at the stack is controlled low during the warm-up, with a resultant tendency to take a long warm-up time.

Even in a travel with the stack and battery warmed up, the motor may require low power, demanding the stack to output low power. For the battery also, demanded output may be low. Such demands may maintain in outdoor low of temperature. The stack and/or battery may thus have a gradually lowered temperature, with a commensurate reduction in available output therefrom.

The present invention is made, with such points in view. It therefore is an object of the invention to provide a fuel cell system and an associated control method, allowing for a fuel cell and a secondary cell to be each respectively adapted for stable power supply to a set of associated loads, even with a maintained low output after complete startup of the system.

According to an aspect of the invention, a fuel cell system comprises a combination of a fuel cell, a power distributor connected to the fuel cell, and a secondary cell connected to the power distributor, a load set connected to the power distributor, and a controller adapted, during distribution of power from the power distributor to the load set after a startup completed with the fuel cell and the secondary cell warmed up, to raise a temperature of the fuel cell when the fuel cell fails to meet a first criterion for a service thereof, and to raise a temperature of the secondary cell when the secondary cell fails to meet a second criterion for a service thereof.

According to another aspect of the invention, there is provided a control method for a fuel cell system comprising a combination of a fuel cell, a power distributor connected to the fuel cell, and a secondary cell connected to the power distributor, and a load set connected to the power distributor, the control method comprising, during distribution of power from the power distributor to the load set after a startup completed with the fuel cell and the secondary cell warmed up, raising a temperature of the fuel cell when the fuel cell fails to meet a first criterion for a service thereof, and raising a temperature of the secondary cell when the secondary cell fails to meet a second criterion for a service thereof

The above and further objects and features of the invention, as well as functions and effects thereof, will be fully apparent from the following best mode for carrying out the invention, when the same is read in conjunction with the accompanying drawings.

### BRIEF DESCRIPTION OF THE DRAWINGS

FIG. 1 is a schematic block diagram of a fuel cell system according to an embodiment of the invention.

FIG. 2 is a detailed block diagram of the fuel cell system of FIG. 1.

FIG. 3 is a flowchart of a control process for a fuel cell stack of the fuel cell system of FIG. 1.

FIG. 4 is a flowchart of a control process for a battery of the fuel cell system of FIG. 1.

FIG. 5 is a longitudinal sectional view of a fuel cell vehicle having a fuel cell system according to another embodiment of the invention.

FIG. 6 is a flowchart of a control process for a battery of the fuel cell system of FIG. 5.

FIG. 7 is a flowchart of another control process for the battery of the fuel cell system of FIG. 5.

### BEST MODE FOR CARRYING OUT THE INVENTION

There will be detailed below preferred embodiments of the invention with reference to the accompanying drawings. Like elements are designated by like reference characters.

### First Embodiment

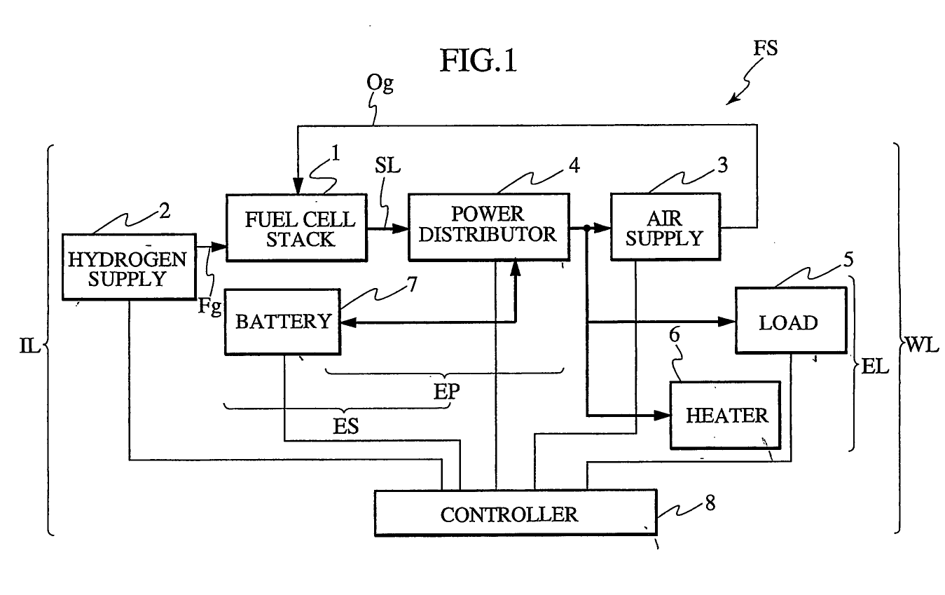

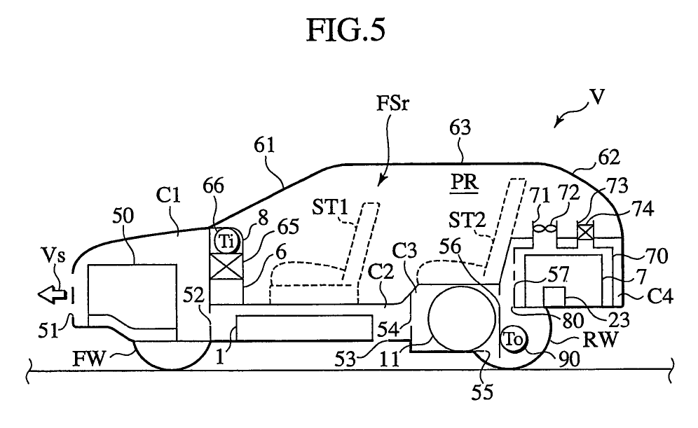

Description is now made of a fuel cell system FS according to a first embodiment of the invention, as the best mode, with reference to FIGS. 1 to 4, and sometimes to FIG. 5.

(Fuel Cell System)

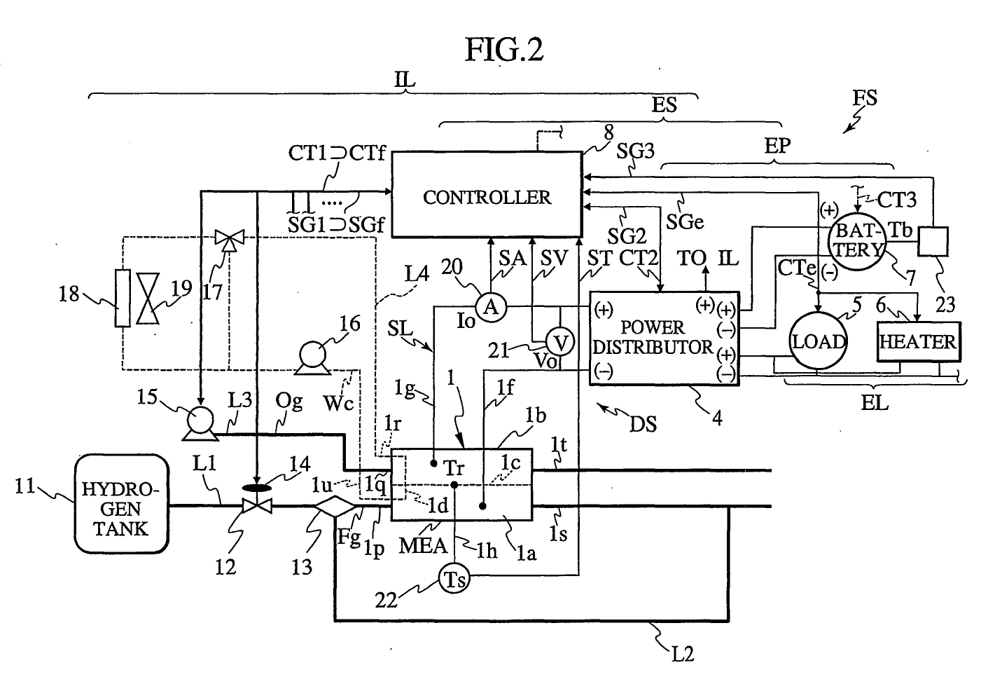

FIG. 1 is a block diagram of the fuel cell system FS, and FIG. 2, a detailed diagram of the same with essential circuits. FIG. 5 is a longitudinal section of a fuel cell vehicle V, on which is mounted a fuel cell system FSr according to a second embodiment of the invention that is configured as a combination of the fuel cell system FS of the first embodiment and a set of later-described additional elements (e.g. battery chamber cooling air fan 72 and air return valve 74).

The fuel cell system FS has a fuel cell stack 1 (FIGS. 1, 2, 5) as an en electric power supply configured to generate and supply electric power, with a gaseous fuel Fg (FIGS. 1, 2) supplied from a hydrogen supply 2 (FIG. 1) and a gaseous oxidizer Og (FIGS. 1, 2) supplied from an air supply 3 (FIG. 1).

The fuel cell system FS is mounted in the vehicle V (FIG. 5) as a fuel-cell-powered motor-driven automobile, and the fuel cell stack 1 is normally adapted to supply sufficient power, via a power supply line SL (FIGS. 1, 2) thereof, to a whole set of associated electrical loads WL (FIG. 1) in the vehicle. The whole load set WL is classified into:

a set of stack-peripherals (e.g. hydrogen supply 2, air supply 3, recirculation line L4 of coolant or thermal medium (hereafter simply “coolant”) Wc, unshown pure water supply line, power distributor 4, and system controller 8 of FIGS. 1-2) as internal loads (hereafter sometimes collectively called “internal load”) IL (FIGS. 1, 2) of the system FS; and

a set of vehicular components (e.g. drive motor as main load 5, and heater 6 of FIGS. 1-2, and air conditioner 65 of FIG. 5) as external loads (hereafter sometimes collectively called “external load”) EL (FIGS. 1, 2) with respect to the system FS.

The internal load IL and some external loads (e.g heater 6 and air conditioner 65 with radiator and fan) serve to support operation of the stack 1, and they are sometimes called “auxiliary equipment” therefor, as used herein. It is noted that the heater 6 is employed to heat the coolant Wc of recirculation line L4, and may constitute the internal load IL in a sense. The auxiliary equipment is categorized into:

a first type that works as a major or relatively variable internal load (i.e. air compressor 15 of FIG. 2);

a second type that works as a minor or relatively invariable internal load (i.e. internal load IL except for air compressor 15, e.g. pump 16 of coolant Wc, cooling fan 19 of radiator 18, inverters in distributor 4);

a third type that serves as external load for heat supply to stack 1 (i.e. heater 6); and

a fourth type that serves as external load for heat supply to battery 7 (i.e. air conditioner 65).

The external load EL is categorized into:

a main or influential load (hereafter simply called “load”) 5 (FIGS. 1, 2) that refers in this embodiment to, but may additionally cover else than, a drive motor (installed in motor casing 50 of FIG. 5) for driving the vehicle V;

a set of stack or battery heating elements (i.e. heater 6 and air conditioner 65) constituting part of the auxiliary equipment; and

a set of power consuming miscellaneous elements, as part of external load EL.

The stack 1 is a lamination of layered unit cells and cell separators as frame members. Each unit cell is formed as a membranous electrode assembly MEA (FIG. 2) between neighboring separators, and configured with a pair of opposing hydrogen and air electrodes 1a, 1b (FIG. 2), and a solid high-polymer electrolyte film 1c (FIG. 2) disposed between the electrodes 1a, 1b.

For power generation, the hydrogen electrode la is supplied with dry or moisturized hydrogen gas, as the fuel Fg, and the air electrode 1b is supplied with dry or moisturized air containing oxygen, as the oxidizer Og. Each electrode 1b, 1c can be cooled (or heated) as necessary by water as coolant Wc (FIG. 2) supplied to a network of coolant paths 1d (FIG. 2) in each cell separator.

It is noted that, for external connection of stack 1, each electrode 1a or 1b (as well as any associated fluid path or detection signal conductor) is connected to, and referred to in terms of, a common (in case of parallel connection), terminal (in case of serial connection), or representative (in case of signal) connection as shown in FIG. 2, for example:

(terminal) anode connection 1f, and (terminal) cathode connection 1g;

(representative) temperature signal connection 1h ; and

(common) fuel supply connection 1p, (common) air supply connection 1q, (common) coolant supply connection 1r, (common) unused fuel collecting connection 1s, (common) waste air collecting connection 1t, and (common) coolant collecting connection 1u.

The hydrogen supply 2 includes, as shown in FIG. 2, a hydrogen supply line L1 connected to a hydrogen tank 11, which line L1 has a hydrogen pressure control valve 12, and a set of ejectors 13 installed downstream the pressure control valve 12. The pressure control valve 12 has a valve actuator 14 as an opening regulator controlled by a corresponding command of a set of fluid control commands (hereafter collectively called “fluid control command” or simply “command”) CTf from system controller 8 (FIGS. 1, 2). The ejector set 13 may also be controlled by fluid control command CTf.

High-pressure hydrogen gas stored in the tank 11 is fed as the fuel Fg to each hydrogen electrode 1a, along the supply line L1, through the control valve 12 where its pressure is controlled, and through the ejector set 13 where it is accompanied with unused hydrogen returned from the hydrogen collecting connection 1s via a return line L2 (FIG. 2). The unused fuel collecting connection 1s has a purge valve (not shown) controlled by fluid control command CTf to make a hydrogen purge of stack 1, as necessary.

The air supply 3 includes, as shown in FIG. 2, an air supply line L3 connected to the air compressor 15 which is adapted for compression of atmospheric air to deliver compressed air. This air is supplied as the oxidizer Og to each air electrode 1b, at a controlled flow rate under a controlled pressure, wherefor fluid control command CTf controls motor rpm (revolutions per minute) and torque of the compressor 15. The air collecting connection It has an air pressure control valve (not shown), of which opening may also be controlled by fluid control command CTf.

As shown in FIG. 2, the stack 1 is provided with the coolant recirculation line L4 for recirculating the coolant Wc through the stack 1. The recirculation line L4 includes a coolant recirculation pump 16, a radiator 18 with a cooling fan 19, and a three-port valve 17 operable for bypassing the radiator 18 to enter a bypass route, where the coolant Wc can be heated by the heater 6 directly or indirectly. Fluid control command CTf controls on-off switching and delivery flow and pressure of the pump 16, as well as port selection of the valve 17 and rpm of the fan 19, to thereby adjust the temperature of coolant Wc.

The above-noted four fluid lines L1 to L4 are all associated with stack 1, and may have their line valves, such as supply main, electromagnetic shutoff, and safety valves, and miscellaneous line controls, which may also be controlled by fluid control command CTf. The stack 1 has its own peripherals (with four fluid lines L1 to L4 inclusive), which are individually controllable by a set of stack peripheral control commands (hereafter collectively called “peripheral control command” or simply “command”) CT1 (FIG. 2), such that command CT1 ⊃ command CTf.

The fuel cell system FS includes a combination of: battery 7 as a secondary cell for electric energy storage or as an accumulator for electric energy accumulation; and a power distributor 4 (FIGS. 1, 2) installed in the power supply line SL of stack 1 and wholly controlled by a distributor control command CT2 (FIG. 2) from the controller 8. It is noted that electric energy is equivalent to a time-integration of electric power. 1f the power supply from stack 1 is insufficient for distribution, the distributor 4 makes the battery 7 discharge, to take out stored energy.

The combination of distributor 4 and battery 7 is configured, under control of the controller 8, to serve, in a sense, as an energy pump EP (FIGS. 1, 2) for pumping energy (or energized electrons) in an accumulating manner that allows a delayed or timing-controlled supply of energy with a linear or non-linear variation in quantity.

For effective service, the battery 7 may have an I/O (input/output) circuit or a parallel-serial switching connection installed between a number of sets of parallel-connected battery cell units and a pair of positive-pole (+) and negative-pole (−) terminals thereof, and adapted to be controlled by a battery control command CT3 (FIG. 2) from the controller 8 to change charge/discharge current and/or voltage at (+) terminal and/or between (+) and (−) terminals, respectively.

The distributor 4 has a number of terminals with (+) or (−) polarity: e.g. pair of (+) and (−) terminals for connection to the battery 7, (−) terminal for a common (−) line, (+) terminal for a common (+) line for power distribution to the external load EL, and (+) terminal for a common (+) line for power distribution to the internal load IL.

The power distributor 4 controls traffic of energy flow, so as to distribute supplied energy from the stack 1, as necessary, to the internal load IL (stack's peripherals with fluid lines L1 to L4, controller 8, distributor 4 itself, battery's I/O circuit or switching connection, if necessary, etc.) and the external load EL (load 5, heater 6, air conditioner 65, etc.), while storing surplus energy in the battery 7.

Power supply to an individual internal or external load IL or EL can be controlled by a corresponding one of three control commands CT1 to CT3 for internal load IL, or by a corresponding one of a set of external load control commands (hereafter collectively called “external load control command” or simply “command”) CTe (FIG. 2), respectively.

The fuel cell system FS has, as shown in FIG. 2, a detection system DS for detecting current conditions of associated system components, fluids, and vehicular components, for example:

working conditions of stack 1, covering an output current lo through cathode connection 1g, an output voltage Vo between anode and cathode connections 1f, 1g, and a stack temperature Ts as a representative temperature Tr of stack 1 (or as a temperature of the coolant Wc);

working conditions of the stack's peripherals with fluid lines L1 to L4 inclusive;

working conditions of distributor 4;

working conditions of battery 7, covering an SOC (state of charge), a battery temperature Tb as a representative temperature of battery 7, an atmospheric air temperature To (FIG. 5) representing a temperature of ambient air or battery 7 within a battery case 70 (FIG. 5) in a battery chamber C4 (FIG. 5), and (if necessary) a charge/discharge current at (+) terminal and/or charge/discharge voltage between (+) and (−) terminals of battery 7;

working conditions of external load EL, including a room temperature Ti (FIG. 5) representing an air temperature in a passenger room PR (FIG. 5) of vehicle V furnished with the air conditioner 65; and

operation or working conditions of vehicular components, e.g. acceleration pedal, ignition key, and vehicle controller.

The detection system DS has necessary detectors, as shown in FIG. 2 and FIG. 5, for example:

a current detector 20 for detecting the output current Io of stack 1 to provide a detection signal SA of current Io, a voltage detector 21 for detecting the output voltage Vo of stack 1 to provide a detection signal SV of voltage Vo, a temperature detector 22 for detecting the stack temperature Ts to provide a detection signal ST representative of temperature Ts;

a set of detection elements (not shown) for detecting the working conditions of the stack's peripherals to provide a set of stack peripheral detection signals (hereafter collectively called “peripheral detection signal”) SG1 representative of these conditions, including detection elements for detecting working conditions of four fluid lines L1 to L4 to provide a set of fluid line detection signals (hereafter collectively called “fluid line detection signal”) SGf representative of these conditions, such that detection signal SG1 ⊃ SGf;

a set of built-in detection elements (not shown) for detecting the working conditions of distributor 4 to provide a set of distributor detection signals (hereafter collectively called “distributor detection signal”) SG2 representative of these conditions;

a combination of battery condition detector 23 (FIGS. 2, 5) and an atmospheric air temperature sensor 90 (FIG. 5), for detecting the SOC, battery temperature Tb, ambient temperature To, and (if necessary) charge/discharge current and/or voltage at or between (+) and/or (−) terminal(s) of battery 7 to provide a battery detection signal SG3 representative of these conditions;

a set of various detection elements (including a room temperature sensor 66 of FIG. 5), for detecting the working conditions of external load EL (including thermal effects on the room temperature Ti), to provide an external load detection signal SGe representative of these conditions; and

a set of necessary detectors and interfaces (including an acceleration pedal angle sensor, an ignition key sensor, a vehicle speed sensor, and an interface with vehicle controller) for detecting the operation or working conditions of vehicular components or receiving control data of vehicle V to acquire vehicular information, which is transmitted and processed as part of external load detection signal SGe.

The detection signal SA of current Io, detection signal SV of voltage Vo, and detection signal ST of temperature Ts are sometimes collectively referred herein to “stack detection signal”.

It will be apparent that the I/O circuit or switching connection of the battery 7 may be removed from the battery 7 to the power distributor 4. In this case, the battery control command CT3 from controller 8 is contained in the distributor control command CT2, and the distributor detection signal SG2 takes, from the battery detection signal SG3, and contains information on the charge/discharge current and/or voltage at or between the (+) and/or (−) terminal(s) of the battery 7.

To this point, the distributor control command CT2 and battery control command CT3 is sometimes collectively referred herein to “energy pump control command”, and the distributor detection signal SG2 and battery detection signal SG3 are collectively referred herein to “energy pump detection signal”.

The fuel cell system FS is wholly governed by the system controller 8 configured as a data processor with a micro computer, memories, interfaces, etc. The controller 8, which has necessary control programs, tables, and data stored in its memory or memories, further:

stores therein respective interfaced data, involving those of the stack detection signal (SA, SV, ST), peripheral detection signal SG1 (with fluid line detection signal SGf inclusive), EP (energy pump) detection signal (SG2, SG3), and external load detection signal SGe; and

executes read program(s) to process such data as necessary for calculation, decision, and/or command to provide the peripheral control command CT1 (with fluid line control command CTf inclusive), EP (energy pump) control command (CT2, CT3), and/or the external load control command CTe,

thereby controlling power generation at the stack 1 and energy flow traffic as well as energy accumulation at the energy pump EP to be both suitable for required power supply to the whole load set WL (i.e. internal load IL, and external load EL).

It will be seen that the energy pump EP (as combination of battery 7 and distributor 4) supplied with power from the stack 1 (i.e. EP+1=1+4+7) constitutes an electric energy supply ES (FIGS. 1, 2) as a power supply for supplying electric energy as power to the whole load set WL in an energy accumulating manner.

In other words, in the fuel cell system FS:

an energy supply (ES) is configured with a fuel cell (1), a power distributor (4) connected to the fuel cell (1), and a secondary cell (7) connected to the power distributor (4); and

the power distributor (4) is controlled from the controller (8) for an efficient warm-up of the energy supply (ES), as well as for power distribution to a whole set of loads (WL).

It is noted that the combination (1+4+7) of stack 1, distributor 4, and battery 7 works as a power supply, but is called herein as “energy supply” ES for identification from stack 1 which inherently serves as a power supply.

For controlling energy supply ES in the system startup, the controller 8 provides stack peripheral control command CT1 and EP control command CT2+CT3, of which combination is sometimes called “ES (energy supply) control command” (CT1+CT2+CT3) that is equivalent to an IL (internal load) control command.

In the startup, therefore, the detection system DS detects the stack 1 together its peripherals, to provide stack detection signal (SA, SV, ST) together with peripheral detection signal SG1, and the energy pump EP, to provide EP detection signal SG2+SG3. All of these (SA, SV, ST, SG1, SG2, SG3) may be collectively called “ES (energy supply) detection signal”, which is a combination of stack detection signal (SA+SV+ST) and IL (internal load) detection signal (SG1+SG2+SG3).

It is noted that the ES detection signal includes EL (external load) detection signal SGe, and the ES control command involves EL (external load) control command Cte, in particular in a normal run in which fractions of generated power are distributed to a whole set of loads including, for example, approx. 60% or more to a drive motor (5, FIG. 2), approx. 2% to an air conditioner (65, FIG. 5), approx. 1% or less to an air compressor (15, FIG. 2), approx. 0.4% to a coolant pump (16, FIG. 2), and 0.5% to electrical appliances such as bead lights, wipers, defogger, radio, etc.

The system controller 8 is configured to serve as an (intra-ES or ES-external) governor or controller to execute:

a “warm-up control” for controlling the combination of stack 1 and battery 7 to be fully warmed up in a startup of fuel cell system FS, in particular under a low-temperature condition, by continuous or pulsatory generation of power at the stack 1 that accompanies commensurate dissipation of stack's own heat, and by a concurrent repetition of cyclic charge and discharge at the battery 7 that also accompanies dissipation of battery's own heat; and

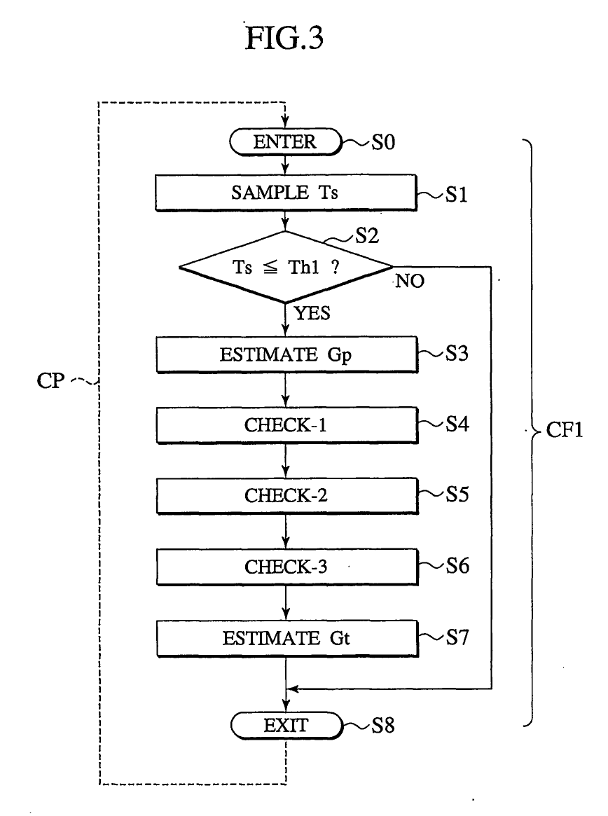

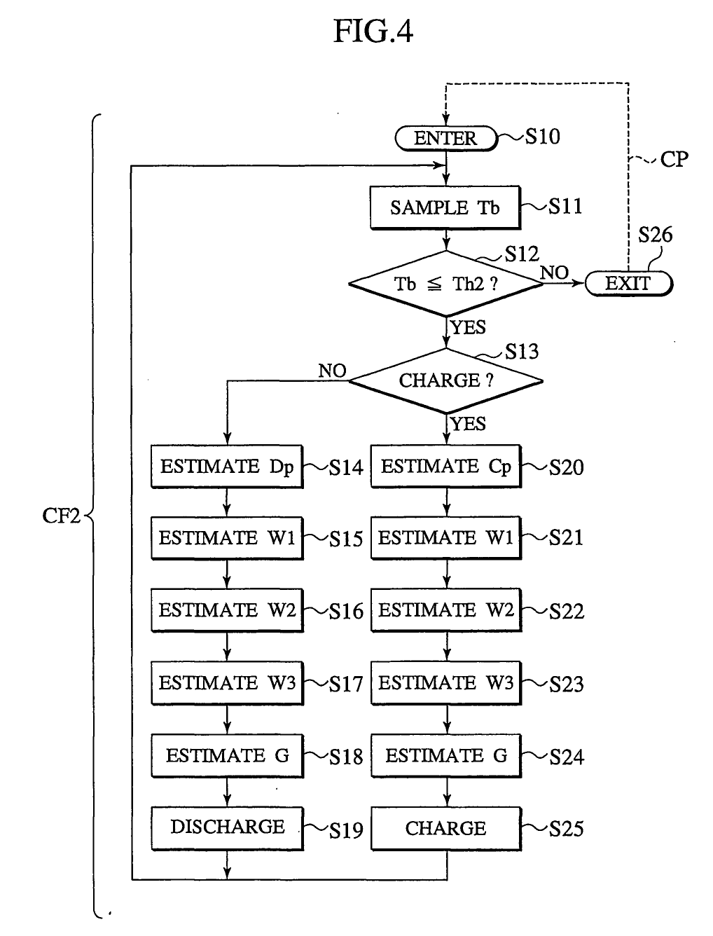

a performance securing normal control CP (FIGS. 3-4) programmed to control the energy supply ES for normal run while securing its energy supply performance, as necessary in each time slot of cyclic control CP after the system startup, in particular under a low temperature condition, including two focused control procedures:
a “stack temperature control” CF1 (FIG. 3) for holding the stack temperature Ts above a threshold Th1 (step S2 of FIG. 3) by increasing power generation of stack 1 up to a possible generation Gp (step S3 of FIG. 3) for increased dissipation of own heat, consuming required power at load 5 and extra power at auxiliary equipment which also generates heat; and
a “battery temperature control” CF2 (FIG. 4) for holding the battery temperature Tb above a threshold Th2 (step S12 of FIG. 4) by operating the battery 7 to discharge (step S19 of FIG. 4) or charge (step S25 of FIG. 4) for increased dissipation of own heat, while running the stack 1 as well as load 5, consuming extra power at auxiliary equipment which also generates heat.

(Stack Temperature Control)

Description is now made of the stack temperature control CF1 of fuel cell system FS, with reference to FIG. 3.

At a step S0, a flow of the performance securing normal control CP enters the stack temperature control FC1, and goes to a step S1.

At the step S1, the stack temperature Ts of a current CP cycle is sampled to be stored. The CP flow goes from the step S1 to a decision step S2.

At the step S2, the stack temperature Ts is compared with threshold Th1 for a decision as to whether Ts≦Th1. The threshold Th1 corresponds to a Ts threshold for a decision to start power supply from stack 1 to load 5 in the system startup, or that for a decision on a warm-up completion of stack 1 in the startup.

If Ts≦Th1, with a decision ‘YES’ (stack 1 needs temperature-rise), the CP flow goes from the step S2 to a sequence of steps S3 to S7. Unless Ts≦Th1, with a decision ‘NO’ (stack 1 does not need temperature-rise), the CP flow goes from the step S2 to a step S8, where it exits the stack temperature control FC1.

The sequence of steps S3 to S7 corresponds to a core of the control CF1, where conditions of stack 1 and load set WL (load 5 and auxiliary equipment) are checked as necessary for estimation of possible generation Gp of stack 1 (step S3), and possible consumption at load set WL, in particular at auxiliary equipment (steps S4 to S7), where power consumption can be increased without influences on the motion of vehicle V. At the load 5 (as drive motor highest of power consumption), it is difficult to change power consumption without significant variations in the output of load 5. For a current power generation, a target generation Gt (step S8) is estimated as an increment to be added thereto to achieve the possible generation Gp of stack 1 in current cycle.

At the step S3, estimation is made to determine the possible generation Gp, for which estimated is a current (Io) vs. voltage (Vo) characteristic curve corresponding to the stack temperature Ts sampled at step S1. For a maximum current Io based on circuitry of system FS, the Io-Vo curve gives a corresponding voltage Vo, allowing for possible generation Gp to be determined as an upper limit of generation. Such curves may be stored in advance as formatted experimental data in a memory, to be read in accordance with sampled stack temperature Ts, or may be determined as a function of temperature Ts and gas supply pressures.

At the step S4, the third type of auxiliary equipment (i.e. heater 6) is checked for an allowance of performance to be available for an increase of its power consumption relative to a current working condition, before estimation of a possible increase thereof. For example, if the heater 6 is out of service, its operation is to start, to thereby increase power generation of stack 1 without influences on drive power of the vehicle V.

At the step 5, the fourth type of auxiliary equipment (i.e. air conditioner 65) is checked for a mode of operation to be available for increase of power consumption relative to a current working condition, before estimation of a possible increase thereof. For example, if the air conditioner 65 is out of service, its operation is to start for increase of power consumption. Even if the air conditioner 65 is already at service, a check is made for a mode of operation controllable for conditioning air to be sent to the passenger room PR to thereby increase the power consumption, before estimation of a possible increase thereof.

At the step S6, the first type of auxiliary equipment (i.e. air compressor 15) is checked for a working point range to be available for increase of power consumption relative to a current working condition, before estimation of a possible increase thereof. For example, the air supply 3 as well as the fuel supply 2 is checked for (a) range(s) of supply flow and/or pressure of its fluid to stack 1 to be available for (a) increase(s) to thereby increase power consumption of compressor 15, before estimation a possible increase of power consumption.

At the step S7, a sum is taken of respective possible increases of power consumption estimated at steps S4 to S6 to determine their total, which is based on as an upper limit in estimation of a target generation Gt to be added to a current generation of power, as a sum of the target generation Gt and the current generation is required not to exceed the possible generation Gp estimated at step S3 in the current cycle.

In other words, if the simple total of possible increases of power consumption and the current generation has a sum exceeding the possible generation Gp, the possible increases of power consumption (at heater 6, air conditioner 65, and compressor 15) are properly adjusted to have a meeting total to be set as the target generation Gt. When the simple total of possible increases of power consumption and the current generation has a sum not exceeding the possible generation Gp, the target generation Gt is set to the simple total.

The fuel supply 2 and the air supply 3 are controlled in accordance with thus set target generation Gt, and the auxiliary equipment (heater 6, air conditioner 65, and compressor 15) is controlled to consume corresponding power. With thus increased power generation and corresponding power consumption, the stack 1 is controlled to have a raised or maintained stack temperature Ts.

At step S2, the decision for the stack temperature Ts to be raised or maintained may be made by the frequency of a fuel purge to be performed downstream the unused fuel collecting connection Is of fuel return line L2.

The fuel purge is performed for a generation characteristic of stack 1 to be maintained against variations of fuel supply condition, due such as to condensed moisture or increased moisture concentration, by discharging part of recirculating fuel at a speed for moisture discharge of fuel supply and return lines L1 and L2, typically when unit cells of stack 1 have dispersed voltages so that some cells have lower voltages than others. This is partly because of occurrences of condensed water in fluid channels of stack 1, where reaction films for power generation have their effective areas decreased by coating condensed water, leading to a reduced power generation performance.

The condensation of water in fluid channel tends to occur typically at locations low of temperature, which means the stack temperature Ts may be assumed decreased, as the frequency of purge (condensed water discharge demand) is increased.

Accordingly, in a modification of the first embodiment, the purge frequency is measured and sampled at step S1, for a decision by a comparison with a threshold therefor at step S2. For an exceeding purge frequency, with a decision that the stack temperature Ts is as low as needing an increased power generation to raise the temperature, the CP flow goes to step S3.

This modification may well be combined with the first embodiment to provide another modification in which both stack temperature Ts and purge frequency are sampled at step S1, and checked at step S2 for a decision to go to step S3, by way of an OR (logical sum) operation therebetween.

(Battery Temperature Control)

Description is now made of the battery temperature control CF2 of fuel cell system FS, with reference to FIG. 4.

At a step S10, the CP flow enters the stack temperature control FC2, and goes to a step S11.

At the step S11, the battery temperature Tb of a current CP cycle is sampled to be stored. The CP flow goes from the step S11 to a decision step S12.

At the step S12, the battery temperature Tb is compared with threshold Th2 for a decision as to whether Th≦Th2. The threshold Th2 corresponds to a Tb threshold for a decision to start power supply from battery 7 to load 5 in the system startup, or that for a decision on a warm-up completion of battery 7 in the startup.

If Th≦Th2, with a decision ‘YES’ (battery 7 needs temperature-rise), the CP flow goes from the step S12 to a sequence of steps S13 to S25. Unless Th≦Th2, with a decision ‘NO’ (battery 7 does not need temperature-rise), the CP flow goes from the step S12 to a step S26, where it exits the battery temperature control FC2.

The sequence of steps S13 to S25 corresponds to a core of the control CF2, where the battery 7 has a raised or maintained temperature by power charge or discharge, i.e., by a duration of charge process in which the stack 1 is controlled for generation of greater power than demanded from the load 5 to have an excess of power generated to be charged to the battery 7, or by a duration of discharge process in which the stack 1 is controlled for generation of smaller power than demanded from the load 5 to have a balance of generated power amended by power discharged from the battery 7. The charge or discharge process is periodically repeated for a continuous charge or discharge accompanying a loss of power to raise or maintain the battery temperature Tb. In FIG. 4, after such charge or discharge, the CP flow goes to the step S11 for comprehension, which may however be changed to the step S26.

At the step S13, a decision is made as to whether the battery 7 is to be charged or not (i.e. discharge). For the decision, a current SOC of battery 7 is sampled. 1f the SOC is greater than a threshold therefor, with decision ‘NO’ (for the battery 7 to discharge), the CP flow enters a discharge mode comprised of a sequence of steps S14 to S19. Unless the SOC is greater than the threshold, with decision ‘YES’ (for the battery 7 to be charged), the CP flow enters a charge mode having a sequence of steps S20 to S25.

For a modification of the second embodiment, at a first time of decision at step S13 after a continued normal run for example, the selection between the charge and discharge modes follows the decision on SOC as described, providing that at a second or subsequent time of decision at step S13 following a decision for the battery temperature Tb to be raised or maintained, the selection between charge and discharge modes may depend on a decision as to whether or not a total duration of consecutive identical modes exceeds a threshold therefor. If a total duration of consecutive discharge modes exceeds the threshold, the CP flow goes to the charge mode. On the contrary, if a total duration of consecutive charge modes exceeds the threshold, the CP flow goes to the discharge mode.

Moreover, during a consecutive discharge mode before a lapse of threshold, if it is detected that the battery 7 is unable to discharge necessary power to amend a balance of power, the CP flow may go to the charge mode. Likewise, during a consecutive charge mode before a lapse of threshold, if it is detected that the battery 7 is unable to charge with an excess of generated power, the CP flow may go to the discharge mode.

If the discharge mode is selected at the step S13, the CP flow goes to the step S14 for estimation of a possible discharge Dp of battery 7. The battery 7 has a reduced discharge performance under a low temperature condition, where it may be insufficiently active. Dischargeable power of battery 7 depends on the SOC as well. If the SOC is high, the possible discharge Dp is large. Along discharge, the SOC becomes low, and the possible discharge Dp decreases. At the step S14, therefore, a current battery temperature Ts and a current SOC of battery 7 are sampled, for estimation of possible discharge Dp. The possible discharge Dp may be read from a stored map of experimental data describing its relationship to a combination of battery temperature Tb and SOC, or determined by a stored expression of such a relationship. The CP flow goes from the step S14 to a step S15.

At the step S15, estimation is made to determine current power consumption W1 by combination of the second type (i.e. minor internal loads IL including coolant recirculation pump 16, fluid line actuators and sensors, and controller power supply), the third type (i.e. heater 6), and the fourth type of auxiliary equipment (i.e. air conditioner 15). For example, current power consumption of the recirculation pump 16 of coolant Wc is calculated from a flow rate command (CTf) thereto, etc. The CP flow goes from the step S15 to a step S16.

At the step S16, estimation is made to determine current power consumption W2 by the first type of auxiliary equipment (i.e. compressor 15). On basses of the possible discharge Dp of battery 7 estimated at step S14 and the power consumption W1 at auxiliary equipment estimated at step S15, additional estimation is made to determine an associated power generation of stack 1, for which supplied air has a corresponding combination of flow rate and pressure to be achieved by a corresponding operation of compressor 15, which is determined to calculate the power consumption W2 at compressor 15. The CP flow goes from the step S16 to a step S17.

At the step S17, estimation is made to determine current power consumption W3 by the load 5 (i.e. drive motor). For this estimation, current vehicular information including a vehicle speed Vs (FIG. 5) and an acceleration pedal angle is processed to calculate demanded drive torque on the motor and necessary power consumption at the motor. The CP flow goes from the step S17 to a step S18.

At the step S18, estimation is made to determine a generation G of power to be achieved by the stack 1, assuming that required power for current total power consumption (W1+W2+W3: at the first to fourth types of auxiliary equipment with compressor 15 inclusive and the load 5) is supplied mainly (i.e. so long as possible) by discharge from the battery 7, with a balance to be supplemented by the generation G of stack 1. The CP flow goes from the step S18 to a step S19.

At the step S19, the hydrogen supply 2 and the air supply 3 are controlled so that the stack 1 is operated to simply serve for the generation G determined at step S18, and concurrently the power distributor 4 is controlled so that commensurate power to the possible discharge Dp determined at step S14 is supplied from the battery 7 to combination of auxiliary equipment and load 5, with a preference to battery 7 over stack 1, thereby promoting dissipation of own heat due to discharge at the battery 7. The CP flow goes from the step S19 to the step S11.

In the case the charge mode is selected at the step S13, the CP flow goes to the step S20, where estimation is made of a possible charge Cp of battery 7 based on a current battery temperature Ts and a current SOC of battery 7 to be sampled. The possible charge Cp may be read from a stored map of experimental data describing its relationship to a combination of battery temperature Tb and SOC, or determined by a stored expression of such a relationship.

The CP flow enters from the step S20 to a sequence of steps S21 to S23, where like the steps S15 to S17 estimation by calculation is made to determine current power consumption W1 and W2 at auxiliary equipment with compressor 15 inclusive, and current power consumption W3 at load 5. The CP flow goes from the step S23 to a step S24.

At the step S24, estimation is made to determine a generation G of power to be achieved by the stack 1, as a total (Cp+W1+W2+W3) of possible charge Cp to the battery 7 and current total power consumption (W1+W2+W3) at the auxiliary equipment with compressor 15 inclusive and the load 5. The CP flow goes from the step S24 to a step S25.

At the step S25, the hydrogen supply 2 and the air supply 3 are controlled so that the stack 1 is operated to serve for the generation G determined at step S24, and concurrently the power distributor 4 is controlled so that necessary power (W1+W2+W3) is supplied from the stack 1 to the auxiliary equipment and load 5, and surplus power commensurate to the possible charge Cp determined at step S20 is supplied from the stack 1 to the battery 7, thereby promoting own heat dissipation of battery 7. The CP flow goes from the step S25 to the step S11.

As the normal control CP is cycled, the battery temperature control FC2 is repeated every cycle, accompanying battery charge or discharge as necessary, whereby battery temperature Tb is raised enough for the battery 7 to have maintained charge and discharge performances.

### Effects of the First Embodiment

According to the first embodiment described, in which after a startup of power supply from warmed energy supply ES to whole load set WL the performance securing normal control CP is continued to raise the stack temperature Ts against reduced possible generation Gp of stack 1 and to raise the battery temperature Tb against reduced possible charge Cp or possible discharge Dp of battery 7, the energy supply ES is adapted for stable power supply the load 5 even under a low temperature condition or even in a situation with a maintained low output condition suppressing own heat dissipation of stack 1 and battery 7.

According to the embodiment, auxiliary equipment for supporting power generation of stack 1 is controlled to consume increased power, and this increment of power is supplemented by increased generation of stack 1, to thereby increase own heat dissipation of stack 1, so that stack temperature Ts can be raised without influences on drive power of vehicle V.

Moreover, power consumption at the air compressor 15 as auxiliary equipment is increased to raise the pressure of air to be supplied to stack 1, and the hydrogen supply 2 is controlled to render small the pressure difference of gases supplied at both sides of a high polymer membrane in the stack 1, so that the fuel supply pressure can be increased by a commensurate fraction to the increase in air pressure, thus allowing an increased velocity of fuel to be purged, with an enhanced purging effect.

Further, power consumption at the air compressor 15 as auxiliary equipment is increased to increase air supply pressure, causing air flow to be increased in the stack 1, with a facilitated discharge of residual product water in gas channels of stack 1.

According to the embodiment, stack temperature Ts is based on for a decision on reduced possible generation Gp of stack 1, with an ensured detection of-a reduced performance for the generation Gp even under a continued low-output condition following a system startup.

According to a modification the embodiment in which a purge frequency is based on for the decision on possible generation Gp of stack 1, advantage is made of the tendency for condensation of water to occur at low-temperature locations in stack 1, which means a decreased stack temperature Ts 1 accompanies an increased purge frequency, allowing for a simplified configuration for decision eliminating complicated operations and extra arrangement therefore.

### Second Embodiment

Description is now made of a fuel cell system FSr according to the second embodiment of the invention, with reference to FIGS. 5 to 7. The fuel cell system FSr is configured as a combination of the fuel cell system FS (FIGS. 1-2) of the first embodiment and additional elements (FIG. 5), as described.

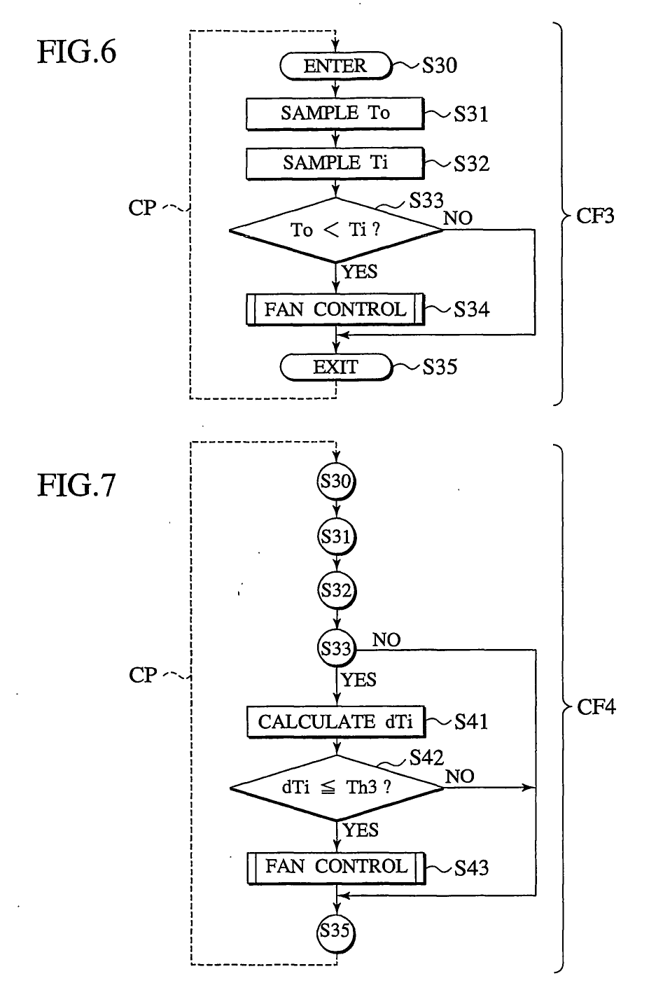

FIG. 5 shows, in a schematic section, a fuel cell vehicle V having the fuel cell system FSr incorporated therein. FIGS. 6 and 7 describe an associated control process CF3 and a modified control process CF4, each respectively as part of the performance securing normal control CP of the first embodiment.

(Fuel Cell Vehicle)

The fuel cell vehicle V is configured with a longitudinal passenger room PR furnished with front and rear sheets ST1 and ST2, a front section having a front chamber C1 and front wheels FW, a lower middle section having a middle front chamber C2 and a middle rear chamber C3 between axles of front and rear wheels FW and RW, and a rear section having a rear chamber C4 and the rear wheels RW.

The passenger room PR is defined by a front windshield 61, a rear windshield 62, a roof member 63 extending therebetween, and a typical combination of floor members, door members, and necessary pillars and wall members.

The passenger room PR has:

at a front end thereof a heater 6 for heating the coolant as medium Wc (FIG. 2), a system controller 8 incorporated in a vehicle controller, a sensor 66 for detecting a representative room temperature Ti of the passenger room PR, an air conditioner 65, and combination of an unshown acceleration pedal and an acceleration pedal angle sensor; and

at a rear part thereof a raised separator for horizontal separation between the passenger room PR and the rear chamber C4, which separator 1 is formed with a pair of front and rear ports 71 and 73 configured for air communication between the passenger room PR and an inside of a battery case 70 built in the rear chamber C4.

The front port 71 has an air fan 72 installed therein and controlled from the controller 8 for drafting air from the passenger room PR into the battery casing 70 to maintain (within a prescribed range) a representative temperature Tb of a battery 7 installed therein together with a battery sensor 23. Normally, the fan 72 is operated for cooling the battery 7 when the battery temperature Tb exceeds a threshold therefor.

The rear port 73 serves as an air return port from inside the battery casing 70 to the passenger room PR, and has a shutoff valve 74 installed therein and controlled from the controller 8 to normally close the port 73. The shutoff valve 74 may be removed.

The front chamber C1 has a motor casing 50 installed therein for covering a main drive motor of the vehicle V, a front grill 51 for introducing atmospheric air from ahead, and rear ports 52 for air communication with the middle front chamber C2.

The middle front chamber C2 has a fuel cell stack 1 installed therein, a bottom grill 53 for air communication with outside of the vehicle V, and rear ports 54 for air communication with the middle rear chamber C3.

The middle rear chamber C3 has a hydrogen tank 11 installed therein, a bottom grill 55 for air communication with outside, and rear ports 56 for air communication with a front opening 80 of the rear chamber C4.

At the rear chamber C4, the battery casing 70 has a front grill 57 for air communication with the front opening 80. The battery casing 70 as well as the rear chamber C4 may rear ports for air communication with outside.

The front opening 80 of the rear chamber C4 has bottom ports for air communication with outside, where a temperature sensor 90 is installed for detecting an atmospheric air temperature To as a battery ambient temperature that varies as the vehicle V runs at a vehicle speed Vs.

(Control Process)

The performance securing normal control CP includes an air fan control process CF3 for raising the battery temperature Tb by operating the air fan 72 to introduce temperature-conditioned air of passenger room PR via the port 71 into the battery casing 70, after a decision that the battery 7 has a reduced performance under a threshold therefor due to a lowered battery temperature Tb under a threshold therefor.

A flow of the normal control CP enters the control process CF3 at a step S30 (FIG. 6), and goes to a step S31.

At the step S31, a current atmospheric air temperature To is sampled. The CP flow goes from the step S31 to a step S32.

At the step S32, a current passenger room temperature Ti is sampled. The CP flow goes from the step S32 to a decision step S33.

At the step S33, a decision is made as to whether To<Ti. If To<Ti, with a decision ‘YES’, the CP flow goes from the step S33 to a step S34. Unless To<Ti, with a decision ‘NO’, the CP flow goes from the step S33 to a step S35, where it exits the control process CF3.

At the step S34, estimation is made to determine target torque of a drive motor of the air fan 72, and this fan 72 is operated with controlled power for the target torque, so that battery temperature Tb is gradually raised from the atmospheric air temperature To to, or maintained at, a temperature (near Ti) of introduced air from the passenger room PR. The CP flow goes from the step S34 to the step S35.

In this embodiment, in place of the atmospheric air temperature To, the battery temperature Tb may be sampled at step S31, to be compared with the room temperature Ti for a similar decision at step S33.

Description is now made of a modification of the second embodiment that follows the modified control process CF4 (FIG. 7), in which the step S34 (FIG. 6) of the second embodiment is modified into a combination of steps S41 to S43 (FIG. 7), where after the decision ‘YES’ at step S33, the CP flow goes to step S41. Remaining steps S30 to S33 and S35 (FIG. 7) are identical to those of the second embodiment (FIG. 6).

At the step S41, a change ratio dTi of room temperature Ti is calculated as a difference between a room temperature Ti sampled in a current cycle and a room temperature Ti sampled in a previous cycle. The CP flow goes from the step S41 to a decision step S42.

At the step S42, a decision is made as to whether dTi≦Th3 (threshold). If dTi≦Th3, with a decision ‘YES’, the CP flow goes from the step S42 to a step S43. Unless dTi≦Th3, with a decision ‘NO’, the CP flow goes from the step S42 to step S35, where it exits the control process CF4.

At the step S43, target torque of fan drive motor is calculated in a fan-action suppressing manner, and the air fan 72 is operated with controlled power for the target torque. In this case also, conditioned air is introduced from the passenger room PR into the battery casing 70, as the atmospheric air temperature is lower than the room temperature Ti (step S33).

However, for a maintained comfortableness in passenger room PR, room temperature change (dTi) is controlled within a range (Th3) by avoiding (‘NO’ at step S42) excessive transfer of conditioned (heated or warmed) air from passenger room PR into battery casing 70, which otherwise might lead to an excessive reduction or delayed rise of room temperature Ti.

Further, in this modification, while the target torque for drive motor of the fan 72 is greater than a threshold therefor, the shutoff valve 74 in port 73 is kept open to thereby allow introduced air in the battery casing 70 to return via the port 73 to the passenger room PR, causing a recirculation of conditioned air therebetween.

The CP flow goes from the step S43 to the step S35, where it exits the control process CF4.

### Effects of the Second Embodiment

According to the second embodiment described, when the battery 7 has reduced performance for charge and discharge, an atmospheric air temperature To corresponding to battery temperature Tb is compared with passenger room temperature Ti, and if this room temperature Ti is higher than the atmospheric air temperature To, the air fan 72 is operated to raise the battery temperature Tb. This control process CF3 is executed in a flow of the normal control CP that includes battery temperature control process CF2 of the first embodiment, thus allowing the battery temperature Tb to be efficiently raised or maintained.

According to a modification of the second embodiment, the operation of air fan 72 is suppressed in consideration of a change ratio dTi of room temperature Ti, so that even in a situation needing a great amount of air to be introduced from passenger room PR into battery casing 70, the temperature Ti of air in the passenger room PR is suppressed to avoid significant decrease, and additionally the pressure of air in the passenger room PR is kept from getting negative without increasing load of an air-conditioning fan constituting the air conditioner 65, allowing for passenger(s) as well as driver to enjoy maintained comfort.

According to the embodiments, therefore, after a start of power supply from a fuel cell (1) and/or a secondary cell (7), a temperature (Ts) of the fuel cell is raised when a possible generation (Gp) of the fuel cell is decreased below a first predetermined value, and a temperature (Th) of the secondary cell is raised when a possible charge (Cp) to the secondary cell or a possible discharge (Dp) from the secondary cell is decreased below a second predetermined value, whereby the fuel cell and the secondary cell are allowed to supply stable power to a load (5) even under a continued low-output condition after system startup.

The contents of Japanese Patent Application No. 2003-137801 are incorporated herein by reference.

While embodiments of the present invention have been described using specific terms, such description is for illustrative purposes, and it is to be understood that changes and variations may be made without departing from the spirit or scope of the following claims.

### INDUSTRIAL APPLICABILITY

The present invention allows a combination of fuel cell and secondary cell to supply stable power to a load even under a continued low-output condition after a startup with complete warmup.

1. A fuel cell system comprising:
a combination of a fuel cell, a power distributor connected to the fuel cell, and a secondary cell connected to the power distributor;
a load set connected to the power distributor; and
a controller adopted, during distribution of power from the power distributor to the load set after a startup completed with the fuel cell and the secondary cell warmed up,
to raise a temperature of the fuel cell when the fuel cell fails to meet a first criterion for a service thereof, and
to raise a temperature of the secondary cell when the secondary cell fails to meet a second criterion for a service thereof.

2. A fuel cell system according to claim 1, wherein the fuel cell has auxiliary equipment therefor as part of the load set, and
the controller is configured to effect an increment of power consumption at
the auxiliary equipment, and to increase power generation of the fuel cell to compensate for the increment, raising the temperature of the fuel cell.

3. A fuel cell system according to claim 1, wherein the first criterion comprises a threshold for a possible generation of the fuel cell.

4. A fuel cell system according to claim 3, wherein the possible generation is estimated in terms of the temperature of the fuel cell.

5. A fuel cell system according to claim 3, wherein
the fuel cell has a fuel recirculating line for fuel supply thereto, and
the possible generation is estimated in terms of a purge frequency of the fuel recirculating line.

6. A fuel cell system according to claim 1, wherein the second criterion comprises a threshold for one of a possible charge and a possible discharge of the secondary cell.

7. A fuel cell system according to claim 6, further comprising a vehicular portion including a passenger room, a cell chamber configured to accommodate the secondary cell, and a fan operable to introduce air from the passenger room to the cell chamber, wherein
the controller is configured to operate the fan to raise the temperature of the secondary cell when a third criterion for the passenger room is met, and
the third criterion comprises a decision for a representative temperature of the passenger room to be higher than a representative temperature of the cell chamber.

8. A fuel cell system according to claim 7, wherein the third criterion comprises a threshold for a changing ratio of the representative temperature of the passenger room.

9. A fuel cell system according to claim 7, wherein the fan comprises an air fan operable to cool the secondary cell.

10. A fuel cell system comprising:
a combination of a fuel cell, a power distributor connected to the fuel cell, and a secondary cell connected to the power distributor;
a load set connected to the power distributor; and
control means for, during distribution of power from the power distributor to the load set after a startup completed with the fuel cell and the secondary cell warmed up,
raising a temperature of the fuel cell when the fuel cell fails to meet a first criterion for a service thereof, and
raising a temperature of the secondary cell when the secondary cell fails to meet a second criterion for a service thereof.

11. A control method for a fuel cell system comprising a combination of a fuel cell, a power distributor connected to the fuel cell, and a secondary cell connected to the power distributor, and a load set connected to the power distributor, the control method comprising, during distribution of power from the power distributor to the load set after a startup completed with the fuel cell and the secondary cell warmed up:
raising a temperature of the fuel cell when the fuel cell fails to meet a first criterion for a service thereof; and
raising a temperature of the secondary cell when the secondary cell fails to meet a second criterion for a service thereof.
